(19) United States
(12) Patent Application Publication
(10) Pub. No.: US 2013/0218611 A1
(43) Pub. Date: Aug. 22, 2013

(54) Computer-Implemented Method for Matching Aggregated Traveler Demand to Aircraft

(71) Applicants: Sascha Mornell, San Francisco, CA (US); Rafael Collado, Chesapeake, VA (US)

(72) Inventors: Sascha Mornell, San Francisco, CA (US); Rafael Collado, Chesapeake, VA (US)

(21) Appl. No.: 13/487,548

(22) Filed: Jun. 4, 2012

Related U.S. Application Data
(62) Division of application No. 13/402,059, filed on Feb. 22, 2012.

(51) Int. Cl. G06Q 10/02; G06Q 30/06; G06Q 50/14

(52) U.S. Cl. 705/5

(57) ABSTRACT

A computer-implemented method for matching aggregated traveler demand to available charter aircraft resources in a real-time manner without incurring costs for unused resources. The method is executed on one or more exemplary computing devices to ingest user requirements for travel, available asset planes, and by using administrative input values determine the best possible match based on the time of day, distance traveled, and equipment efficiency.

### RELATED APPLICATIONS

This patent is related to U.S. patent application Ser. No. 13/402,059 by Sascha Mornell, et al., filed on Feb. 22, 2012 and entitled “Method and System for Aggregating Travelers to Transact Air Travel Reservations,” assigned to the assignee of the present invention.

### FIELD

The present disclosure relates to computer systems, in particular a computer-implemented method for matching aggregated traveler demand to available charter aircraft resources via a user driven asset management and exchange platform.

### BACKGROUND

Air travel is becoming an ever increasingly predominant method of travel. Travelers, however, possess limited options for air travel reservations. There are two broad options for air travel—commercial air travel and private air travel. Customer satisfaction in the commercial air travel industry is at an all-time low. Increasing crowds, enhanced security, and increasingly prevalent delays all contribute to an unpleasant travel experience. While private air travel remedies many of the disagreeable aspects of commercial air travel, it is cost prohibitive to the average traveler. Currently the exclusive method for suppliers of private air travel to market and sell private air travel services is through chartering flights by the plane, by the hour. This model requires that a traveler, or group of travelers, coordinate payment for the entire plane reservation. Not surprisingly, private air travel is essentially limited to institutional clients and individuals with substantial financial means. Furthermore, this method is inefficient and requires substantial coordination between travels and flight operators.

Air travel companies manage yield through fixed asset systems. This is the case for both direct sales companies, for example private airlines, and travel agent or wholesale companies, for example an online travel site. In these systems, if assets go unsold the supplier incurs the loss of the unsold asset. These systems perpetuate inefficiency and contribute to the high costs of private and commercial air travel.

What is needed, therefore, is a method that aggregates traveler demand to correspond with dynamic supply parameters, such that inefficiency is reduced at a supply level and costs are reduced at a consumer level. An effective method of remedying asset yield inefficiency, while simultaneously enabling travelers to aggregate demand in response to available aircraft assets, has eluded those skilled in the art.

### SUMMARY

To establish a platform using a yield management algorithm that extends existing statistical yield management methods through the use of a weighted variable to match aggregated traveler demand along a sliding scale of available charter aircraft resources in a real-time manner without incurring costs for unused resources.

To execute operations via a networked computer platform to ingest user requirements for travel and available asset aircraft, and to determine using administrative input values the best possible match for those requirements based on the time of day, distance traveled, and equipment efficiency.

A computer-implemented method for transacting air-travel reservations, the method comprising receiving user-generated travel data on one or more networked computers; assigning asset management values and demand management values to the user-generated travel data, the values being stored on a computer-readable medium; aggregating the demand management values; determining conforming yield between the asset management values and the demand management values; and determining a reservation outcome.

Another embodiment is a computer-implemented method for creating air-travel reservations, the method comprising receiving user travel data input via a communications interface on one or more networked computers, the user travel data input being stored in at least one asset management database; comparing the user travel data input stored in the at least one asset management database; determining a conforming yield outcome, the conforming yield outcome being determined through establishing asset parameters and demand parameters within the asset management database; and determining a reservation outcome, the reservation outcome being determined by matching complementary asset parameters to demand parameters as established within the asset management database.

An embodiment is a computer-implemented method for matching air travel suppliers with travelers, the method comprising receiving over a communication network, by a communication handler program executing on a networked computer, supply information from a remote computer of a first entity corresponding to air travel reservation options, the information received via a communication network from the remote computer of at least one first entity including (i) input relating to one or more air travel route parameters, and (ii) input relating to air travel reservation cost parameters; processing via the network computer at least a portion of the received information from a database format into a world wide web presentation format, the presentation format including at least a portion of the input relating to the one or more air travel route parameters, and the input relating to the air travel cost parameters; receiving over a communication network, by a communication handler program executing on a networked computer, demand information from a remote computer of one or more demand entities corresponding to air travel reservation demand, the information received via a communication network from the remote computer of the one or more demand entities including (i) input relating to one or more air travel route parameters, and (ii) input relating to air travel reservation cost parameters; and automatically initiating a reservation match process to create an air travel reservation between the at least one first entity and the one or more demand entities based at least in part on the information received via the communication network from the at least one first entity and the one or more demand entities; wherein the automatically initiated reservation match process creates a reservation by performing operations to include: aggregating the demand information from the one or more demand entities; determining conforming yield between the at least one first entity input parameters and the one or more demand entities input parameters; creating an air travel reservation between the at least one first entity and the one or more demand entities.

These and other advantages will become clearer in the following drawings, descriptions, and claims.

### BRIEF DESCRIPTION OF DRAWINGS

FIG. 1 is a block diagram of a typical computer system into which one implementation of the present invention may be incorporated.

FIG. 2 is schematic block diagram showing the logic flow of matching traveler information to available aircraft assets.

FIG. 3 is a schematic block diagram of a subroutine executed during the logic flow of matching information to available aircraft assets.

FIG. 4 is a schematic block diagram of a subroutine executed during the logic flow of matching information to available aircraft assets.

FIG. 5 is a schematic block diagram of a subroutine executed during the logic flow of matching information to available aircraft assets.

FIG. 6 is a schematic block diagram of a subroutine executed during the logic flow of matching information to available aircraft assets.

### DETAILED DESCRIPTION

While it would seem that there is an infinite amount of capacity in the commercial air charter business, the actual availability of planes is severely limited by the lack of transparency or ready access to the locations, real capacities and itineraries of specific charter aircraft. Aspects of the present invention increase transparency, traveler convenience, charter provider profitability and overall transparency in this market.

Reference will now be made in detail to various embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, protocols, services, components, and circuits have not been described in detail so as not to unnecessarily obscure aspects of the present invention.

### Exemplary Computing Device

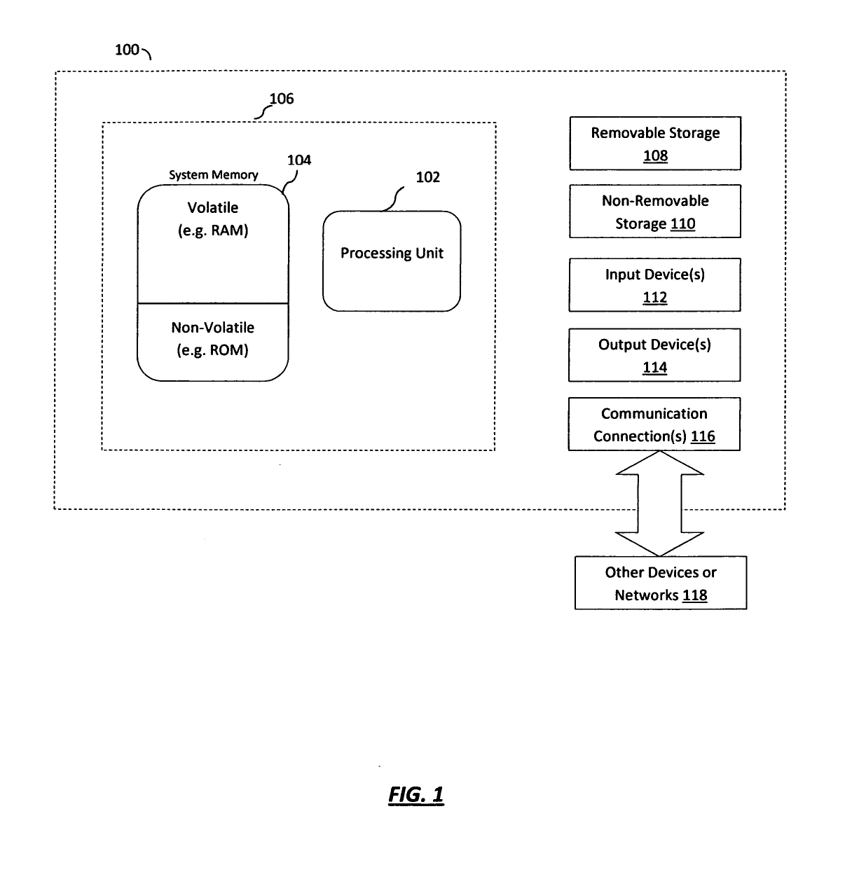

In an embodiment, FIG. 1 is a functional block diagram generally illustrating a computing device 100, one or more of which may be adapted for use in the illustrative system for implementing the invention. The computing device may be, for example, a personal computer, a handheld device such as a cell phone or tablet computer, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In its most basic configuration, computing device 100 typically includes at least one processing unit 102 and system memory 104. Depending on the exact configuration and type of computing device, system memory 104 may be volatile (such as RAM), non-volatile (such as ROM, flash memory, etc.), or some combination of the two. The basic configuration of the device 100 is illustrated in FIG. 1 within the dashed line 106.

Device 100 may also have additional features and functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and non-volatile, removable and non-removable media implemented in any method or technology for storage of information such as computer readable instruction, data structures, program modules, or other data. System memory 104, removable storage 108, and non-removable storage 110 are examples of computer storage media. Computer storage media includes, but is not limited to RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be access by device 100. Any such computer storage media may be part of device 100.

Device 100 includes one or more input devices 112 such as a keyboard, mouse, pen, puck, voice input device, touch input device, scanner, or the like. One or more output devices 114 may also be included, such as a video display, audio speakers, a printer, or the like. Input and output devices are well known in the art and need not be discussed at length here.

Device 100 also contains communications connection 116 that allows the device 100 to communicate with other devices 118, such as over a local or wide area network. Communications connection 116 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g. radio frequency), infrared, and other wireless media. The term computer readable media as used herein includes both storage media and communication media.

### Computer Implementation

In an embodiment of the invention, the below steps can be accomplished all at once or at predetermined time intervals. This determination may be made based upon administrative values including the number of days until flight execution and the number of interested travelers for a given flight option. It is anticipated an embodiment may be configured to operate in a different order as to that illustrated below, and may substitute or eliminate some or all of the logic steps illustrated in the various routines and subroutines. Regardless of the chosen routines or subroutines used to execute the logic of the invention, the basic components of the method implementation include, but are not limited to, (1) data ingestion, (2) yield management process, and (3) route asset database.

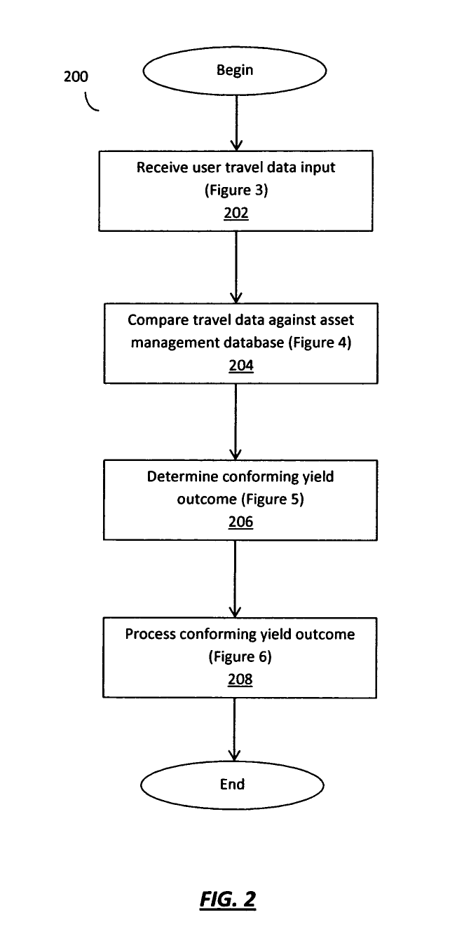

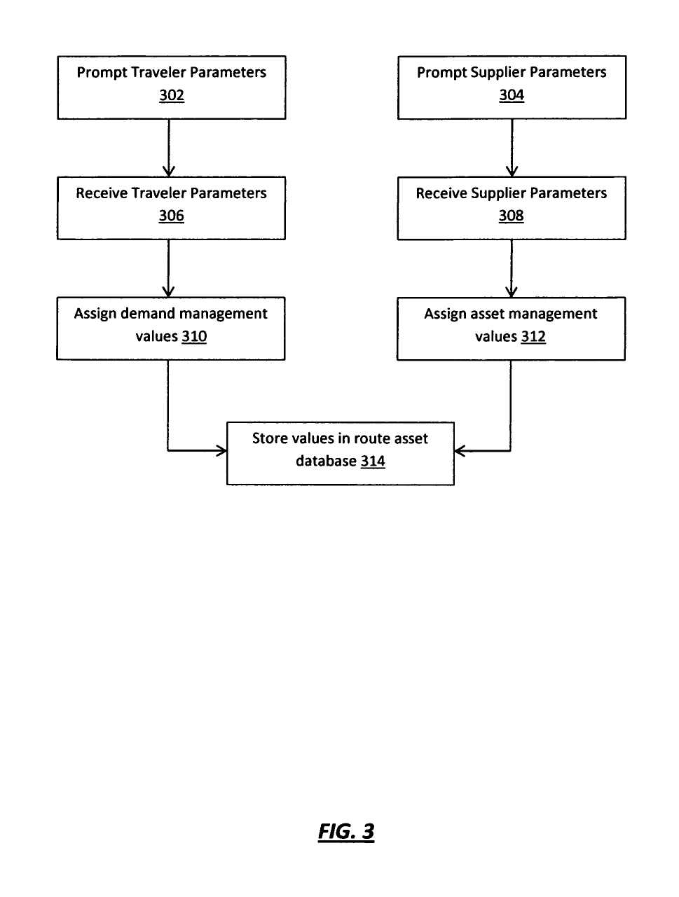

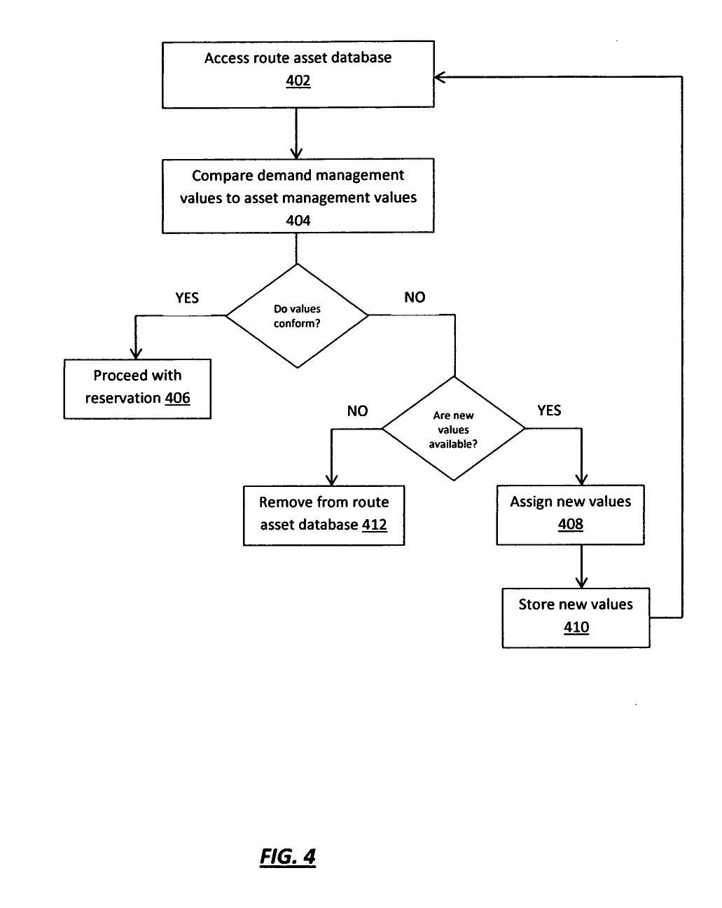

In an embodiment, FIG. 2 is schematic block diagram showing the logic flow of matching traveler information to available aircraft assets. Method 200 operates to match traveler demand to available aircraft assets through a real-time, user-driven asset management and exchange platform. In an embodiment, the logic of method 200 is executed by an internal or external microprocessor operably engaged with an exemplary computing device configured to receive input values from one or more users via a communications network. Method 200 may be executed by first receiving user travel data input 202 (as illustrated in an embodiment by FIG. 3). User travel data input is meant to include air travel supplier data input and traveler data input. Air travel supplier data input may include, but is not limited to, Federal Aviation Association (FAA) 135 certification number; contact e-mail; contact phone; company name; address; an account password; plane tail number; base airport; aircraft type; aircraft manufacturer; aircraft model; blackout dates; passenger and cargo weight requirements; usable seats; aircraft description; images; reservation parameters, including aircraft availability, aircraft status, flight destination, total requested price for flight, flight schedule, and flight frequency. Traveler data input is meant to include especially, but is not limited to, the traveler's first and last name; contact e-mail; account password; passenger or passengers' names and dates of birth; and credit card information, including billing address, billing city, billing state, billing zip, name on card, card number, expiration month, expiration year, and security code.

In an embodiment, user travel data input 202 is communicated to an exemplary computing device configured to execute the logic of method 200 via the use of one or more Web pages across and Internet connection. Upon receipt of user travel data input 202, method 200 compares the travel data against an asset management database 204 (as illustrated in an embodiment by FIG. 4). An asset management database may be any suitable computer storage medium capable of storing travel data input values for on-demand access. When method 200 compares the travel data against the asset management database 204 it utilizes administrative input values to determine the best match between travel demand parameters and supplier asset parameters stored within the asset management database. A unique component of the algorithms used by the combined software and database is the use of a “bias” variable to more exactly conform demand to the best matched available asset.

Historically, most yield management systems in the airline or charter business sought optimal yield along a single continuum or curve. This curve was typically constrained by time and geography. In an embodiment of the present invention, the number of travelers may be used as a “bias” variable that provides a definitive intercept across a broad range of capacity curves. The embodiment may then choose the curve that yields the maximum convenience for the traveler and profit for the air travel supplier. FIG. 7 graphically depicts the bias variable mapped onto the yield continuum.

The different curves represent the yield continuum which is the sum of the probabilities of 1 geographic location, 2 aircraft size, 3 route and 4 time. The dotted line 5 represents the bias variable and its point of intersection is the value of the first order derivative at that point in the yield curve. This first order derivative is the optimum match for demand versus capacity.

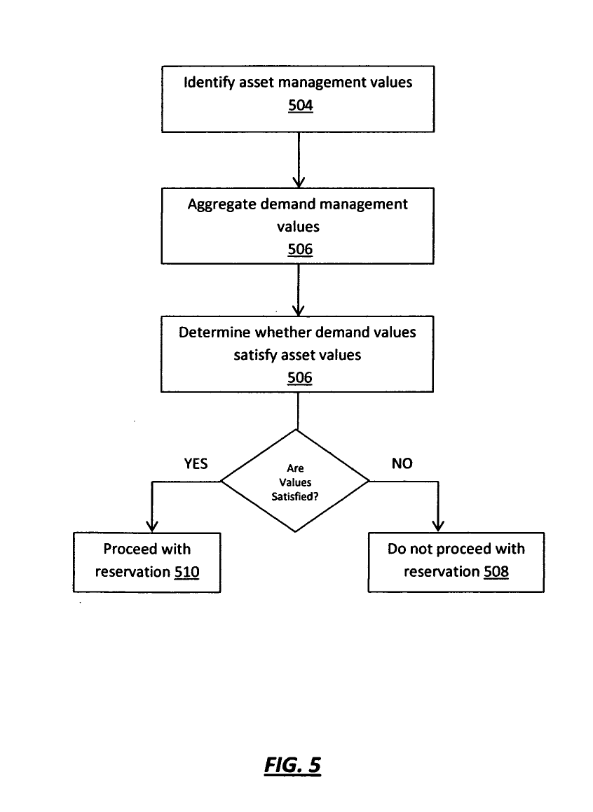

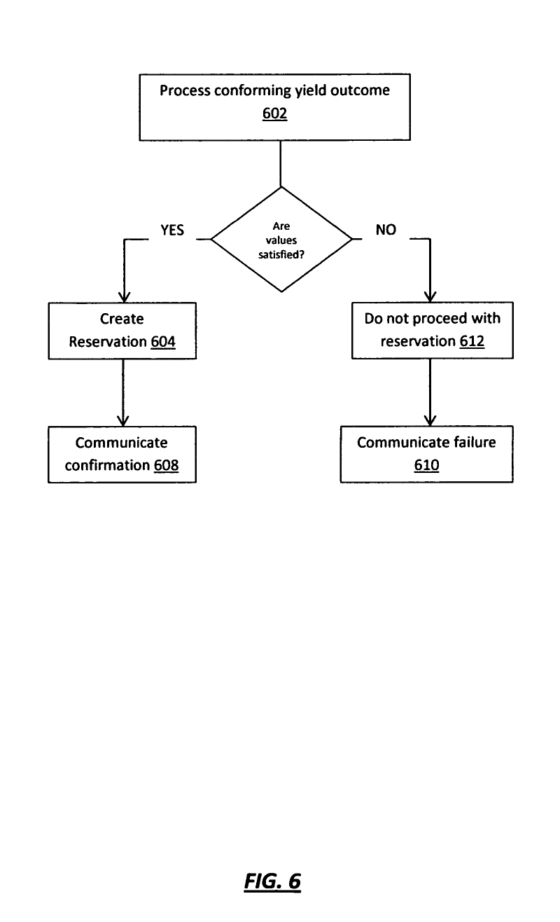

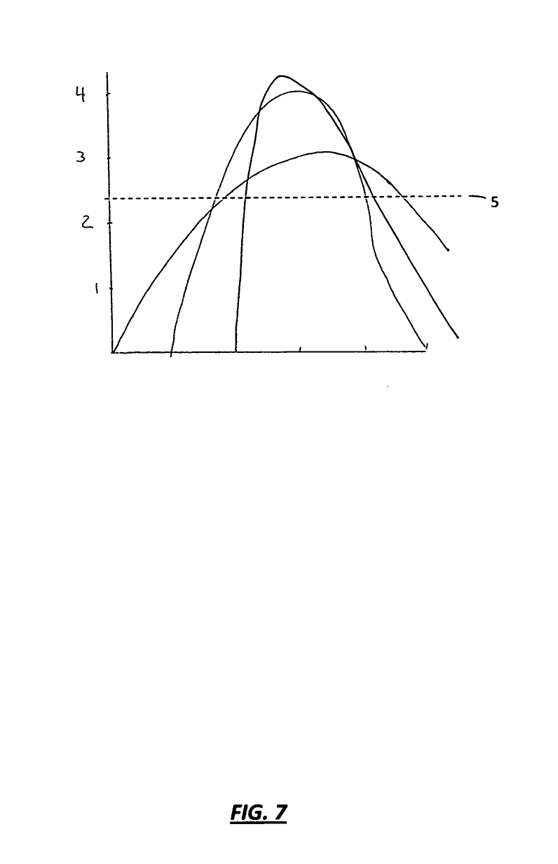

Upon comparing travel data against asset management database 204, method 200 operates to determine a conforming yield outcome 206 (as illustrated in an embodiment by FIG. 5). The conforming yield outcome is a determination of whether the demand parameters provided by travelers satisfy the asset parameters provided by aircraft suppliers. Upon determining conforming yield outcome 206, method 200 operates to determine a reservation outcome 208 (as illustrated in an embodiment by FIG. 6). If demand parameters provided by one or more travelers in the aggregate satisfy the asset parameters provided by the aircraft suppliers, a reservation is created to match the travelers to the air-travel suppliers. If demand parameters provided by one or more travelers in the aggregate do not satisfy the asset parameters provided by the aircraft suppliers, a failure message may be communicated to both the travelers and suppliers so as to avoid or mitigate inefficient use of the aircraft asset.

The following is an illustrative example of method 200 as applied in an e-commerce scenario. An exemplary computing system, configured to execute the logic of method 200 through the use of one or more computer processing units (CPU), displays through the use of one or more Web pages via an Internet connection data input fields for both travelers seeking air travel reservations and air travel suppliers over a World Wide Web site. Travelers and suppliers may access the Web site through a remote exemplary computing device with an Internet connection. Travelers and suppliers arrive at the site and may be prompted to follow either a supplier scenario or a traveler scenario. In the supplier scenario, one or more input fields may be available for suppliers to communicate available asset parameters to the asset management database within the exemplary computing device, e.g. available planes, routes, locations, and prices. Upon submission of the asset parameters, the supplier-generated input may be assigned administrative input values based upon air-travel provider attributes, air-travel route attributes, and plane attributes. These administrative input values may be used as the bases of matching traveler demand with available assets.

In the traveler scenario, one or more input fields may be available for travelers to communicate demand parameters to at least one database in the exemplary computing device, e.g. date, time, and location of an advertised flight and price offered by traveler. Method 200 may function to aggregate demand parameters across multiple travelers in real-time, geographically, and by price. The demand parameters, whether alone or aggregated with other demand parameters, may be analyzed against the asset parameters in the asset management database to find a suitable asset match to satisfy the demand needs. If a match is available, a confirmation request is communicated to the traveler, and upon communication by the traveler of confirmation, a reservation is created to match the supplier asset with the traveler demand. If a match is not available, a failure message is communicated to the traveler and an option to resubmit demand parameters is communicated. For example, if four seats are available on a flight communicated by a supplier at a cost of $500 per seat and only one traveler requests a one-seat reservation, at some point prior to the execution of the flight, for example 48 hours, method 200 may operate to communicate to the traveler that in order for the flight to proceed, the additional three seats will need to be purchased. If the traveler wishes to proceed with the flight, the traveler will purchase the other three seats for a total flight cost of $2,000. If the traveler does not wish to purchase the seats, the flight will not be completed and the reservation will be cancelled.

FIG. 3 is a schematic block diagram of a subroutine executed during the logic flow of method 200. In an embodiment, method 200 prompts traveler parameters 302 and supplier parameters 303 through the use of one or more Web pages over an Internet connection. Traveler and supplier parameters may be prompted through the use of one or more input boxes on a dynamic Web page interface. The exemplary computing system may receive traveler parameters 306 and supplier parameters 308 via submission over an Internet platform. Upon receipt of traveler parameters 306 and supplier parameters 308, method 200 operates to assign demand management values 310 to traveler parameters, and asset management values 312 to supplier parameters. Management values are assigned using predetermined categorization of input data to include, but not limit to, flight location, price, number of seats, and flight dates and times. Upon assigning management values, the values may be stored in a route asset database 314 so as to be accessed for aggregation of demand management values and comparison of asset management values to demand management values.

FIG. 4 is a schematic block diagram of a subroutine executed during the logic flow of method 200. In an embodiment, method 200 operates to access 402 a route asset database. Access 402 of the route asset database operates to search or compare 404 the demand management values to the asset management values stored in the route asset database. Method 200 operates to determine whether the demand management values conform to the asset management values. If the values conform, then method 200 proceeds with steps for creating a reservation between the traveler and supplier. If the values do no conform, method 200 operates to determine whether new values can be obtained through communication of a request for new values from the traveler, e.g. determine whether the traveler is willing to pay more for the flight or accept a different flight. If the traveler communicates new demand parameters, then new demand management values are assigned 408 to the demand parameters. The new values are then stored 410 in the route asset database, and accessed 402 to determine conforming yield with asset management values. If new values are not available, e.g. the traveler is not willing to pay more for the flight or take a different flight, the non-conforming demand management values are removed 412 or deleted from the asset management database and method 200 does not proceed with reservation steps. In this case, the traveler will not be able to obtain an air travel reservation and the supplier will not execute the intended flight.

FIG. 5 is a schematic block diagram of a subroutine executed during the logic flow of method 200. In an embodiment, method 200 operates to identify 502 asset management values within the route asset database. Demand management values are aggregated 504 by grouping demand management values having the same or similar parameters. Method 200 then determines 506 whether the aggregated demand values satisfy the asset values by matching the demand values to complementary asset values, e.g. a traveler or travelers' requested route, departure, and price matches that of the supplier's offered route, departure, and price. If the demand values satisfy the asset values, method 200 proceeds with reservation 510. If the demand values do not satisfy the asset values, method 200 does not proceed with reservation 512.

FIG. 6 is a schematic block diagram of a subroutine executed during the logic flow of method 200. In an embodiment, method 200 operates to process 602 the conforming yield outcome. If yield outcome is positive, meaning the asset management values are satisfied by the demand management values, method 200 matches the traveler to the supplier and creates a flight reservation. Method 200 may be further operable to execute a financial transaction with the traveler upon confirmation of the flight reservation. A confirmation may then be communicated 608 to the supplier and traveler via a communications interface. If the outcome is negative, method 200 does not proceed 606 with the flight reservation and a failure is communicated 610 to the supplier and traveler via a communications interface.

Although the present invention has been described with several embodiments, numerous changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A computer-implemented method for transacting air-travel reservations, the method comprising:
receiving user-generated travel data on one or more networked computers;
assigning asset management values and demand management values to the user-generated travel data, the values being stored on a computer-readable medium;
aggregating the demand management values;
determining conforming yield between the asset management values and the demand management values upon analysis of a bias variable; and
determining a reservation outcome.

2. The computer-implemented method of claim 1 wherein the user-generated travel data is communicated via an Internet connection.

3. The computer-implemented method of claim 1 wherein the demand management values are aggregated through the use of at least one microprocessor.

4. The computer-implemented method of claim 1 wherein determining conforming yield is accomplished by performing operations to include (i) comparing asset management values to demand management values, and (ii) matching compatible asset management values with demand management values.

5. The computer-implemented method of claim 1 wherein the user-generated travel data is categorized by predetermined input criteria.

6. The computer-implemented method of claim 1 wherein at least a portion of the user-generated travel data is displayed through the use of one or more Web pages.

7. The computer-implemented method of claim 1 further comprising communicating a failure message to a user upon determining an absence of conforming yield between the asset management values and the demand management values.

8. A computer-implemented method for creating air-travel reservations, the method comprising:
receiving user travel data input via a communications interface on one or more networked computers, the user travel data input being stored in at least one asset management database;
comparing the user travel data input stored in the at least one asset management database;
determining a conforming yield outcome, the conforming yield outcome being determined through establishing asset parameters and demand parameters within the asset management database; and
determining a reservation outcome, the reservation outcome being determined by matching complementary asset parameters to demand parameters as established within the asset management database.

9. The computer-implemented method of claim 8 wherein the asset parameters and demand parameters are assigned based on at least a route and price input by a user.

10. The computer-implemented method of claim 8 wherein determining conforming yield is automatically initiated by performing operations to include (i) aggregating the demand parameters, and (ii) matching the demand parameters as aggregated to conforming asset parameters.

11. The computer-implemented method of claim 8 further comprising executing a financial transaction upon determining a successful reservation outcome.

12. The computer-implemented method of claim 8 wherein operations for determining the conforming yield and determining the reservation outcome are executed through the use of at least one microprocessor.

13. The computer-implemented method of claim 8 further comprising communicating a request to a user for input of new demand parameters.

14. The computer-implemented method of claim 8 further comprising communicating a failure message to a user upon determining non-conformance of the asset parameters and demand parameters.

15. The computer-implemented method of claim 14 wherein the failure message prompts a user to input new demand parameters to conform to existing asset parameters within the asset management database.

16. A computer-implemented method for matching air travel suppliers with travelers, the method comprising:
receiving over a communication network, by a communication handler program executing on a networked computer, supply information from a remote computer of a first entity corresponding to air travel reservation options, the information received via a communication network from the remote computer of at least one first entity including (i) input relating to one or more air travel route parameters, and (ii) input relating to air travel reservation cost parameters;
processing via the network computer at least a portion of the received information from a database format into a world wide web presentation format, the presentation format including at least a portion of the input relating to the one or more air travel route parameters, and the input relating to the air travel cost parameters;
receiving over a communication network, by a communication handler program executing on a networked computer, demand information from a remote computer of one or more demand entities corresponding to air travel reservation demand, the information received via a communication network from the remote computer of the one or more demand entities including (i) input relating to one or more air travel route parameters, and (ii) input relating to air travel reservation cost parameters; and
automatically initiating a reservation match process to create an air travel reservation between the at least one first entity and the one or more demand entities based at least in part on the information received via the communication network from the at least one first entity and the one or more demand entities;
wherein the automatically initiated reservation match process creates a reservation by performing operations to include:
aggregating the demand information from the one or more demand entities;
determining conforming yield between the at least one first entity input parameters and the one or more demand entities input parameters;
creating an air travel reservation between the at least one first entity and the one or more demand entities.

17. The computer-implemented method of claim 16 further comprising communicating a request for new input parameters to the one or more demand entities over a networked communication interface upon determining non-conforming yield between the at least one first entity input parameters and the one or more demand entities input parameters.

18. The computer-implemented method of claim 17 wherein new input parameters are received via a communication network from the remote computer of the one or more demand entities.

19. The computer-implemented method of claim 17 further comprising communicating a failure message to the at least one first entity and the one or more demand entities upon failure to receive the new input parameters after a predetermined time.

20. The computer-implemented method of claim 18 wherein the new input parameters are predetermined to conform to the at least one first entity input parameters.
